(19) United States
(12) Patent Application Publication
(10) Pub. No.: US 2012/0321944 A1
(43) Pub. Date: Dec. 20, 2012

(54) ELECTRODE STRUCTURAL BODY FOR BATTERY MODULE

(75) Inventor: Ryuhei Nishida, Yokohama-shi (JP)

(73) Assignee: NIFCO INC., Yokohama-shi, (JP)

(21) Appl. No.: 13/578,477

(22) PCT Filed: Feb. 15, 2011
(86) PCT No.: PCT/JP2011/053159

§ 371 Date: Aug. 27, 2012

(30) Foreign Application Priority Data
Feb. 19, 2010 (JP) 2010-034523

(51) Int. Cl. H01M 2/06

(52) U.S. Cl. 429/179

(57) ABSTRACT

An external connecting portion of a conducting member is an upright portion formed by folding an end portion of a metal plate, and an outer face of the upright portion is exposed outside a battery module. Also, in the upright portion, a cylindrical portion, including a female screw on an inside protruding from the inner face of the upright portion, is formed. The cylindrical portion is formed by a press work relative to the metal plate, and in the cylindrical portion, the female screw is formed by a cutting work. An insulation cover includes a first part covering the inner face of the upright portion, and the cylindrical portion; and a second part engaged and combined with the first part in such a way that the first part and the second part sandwich a portion positioned immediately below the cylindrical portion in the conducting member.

### FIELD OF TECHNOLOGY

The present invention relates to an improvement of an electrode structural body which becomes one portion of a battery module structuring a storage system for a hybrid car, an electric car, and the like, and forms an electrode of the battery module.

### BACKGROUND ART

The storage system for the hybrid car and the like is structured by a plurality of battery modules. Also, in each battery module, a storage body cell forming a flat plate shape is housed in a case in a stacking manner. In the case of the battery module, there is provided the electrode electrically connected to a storage body cell in an inside, and by using the electrode, a connection to a terminal outside the battery module is carried out. The electrode of such battery module is provided in the aforementioned case at two portions or more (see Patent Document 1).

### PRIOR ART DOCUMENT

### Patent Document

Patent Document 1: Japanese Unexamined Patent Publication No. 2009-231267

### SUMMARY OF THE INVENTION

### Problems to be Solved by the Invention

A main problem which the present invention attempts to solve is how to become capable of appropriately structuring the electrode of this kind of battery module with the minimum number of components.

### Means for Solving the Problems

In order to achieve the aforementioned object, in the present invention, an electrode structural body for a battery module is an electrode structural body forming an electrode of the battery module in which a storage body cell is housed in a case, and is structured by a conducting member made by a metal plate, and an insulation cover made from synthetic resin. The conducting member comprises an internal connecting portion electrically connected to the storage body cell, and an external connecting portion electrically connected to a terminal outside the battery module. The external connecting portion is an upright portion formed by folding an end portion of the aforementioned metal plate, and an outer face of the upright portion is exposed outside the battery module. Also, in the upright portion, there is formed a cylindrical portion comprising a female screw on an inside protruding from an inner face thereof. The cylindrical portion is formed by a press work relative to the aforementioned metal plate, and in the cylindrical portion, there is formed the female screw by a cutting work. The insulation cover comprises a first part covering at least the inner face of the upright portion, and the cylindrical portion; and a second part engaged and combined with the first part in such a way that the first part and the second part sandwich a portion located immediately below the cylindrical portion in the conducting member.

One of preferred embodiments is that the first part includes a front face abutted against the inner face of the upright portion, and also that the first part comprises a housing portion of the cylindrical portion communicated with a through hole formed in the front face.

According to such structure, first, an electrode side of the battery module electrically connected relative to the terminal outside the battery module, i.e., an upright portion side of the conducting member, can be easily and appropriately covered by the insulation cover in which the first part and the second part are combined. Since the first part and the second part can be structured by simple synthetic resin molding, the cost of components can be minimum. Also, according to such electrode structural body, secondly, a connection of the terminal outside the battery module into the upright portion of the conducting member can be carried out by a bolt screwed into the cylindrical portion. Also, the cylindrical portion is integrally provided in the conducting member by the press work, so that a separate nut and the like are not required so as to minimize the number of components from this perspective as well. Also, in that way, an area of the outer face of the upright portion making a contact with the terminal outside the battery module can be secured in as large an area as possible.

If the second part includes a pair of side walls housing at least one portion of the first part therebetween, an insulating distance can be effectively increased due to an overlapping margin of such first part and the second part.

### Effect of the Invention

According to the present invention, the electrode of the battery module can be appropriately structured with the minimum number of components.

### BRIEF DESCRIPTION OF THE DRAWINGS

FIG. 1 is a perspective structural view of a battery module according to one of embodiments of the present invention.

FIG. 2 is a perspective structural view showing a state wherein an electrode structural body, an electrode of a storage body cell, and a terminal outside the battery module in the embodiment of the present invention are separated.

FIG. 3 is an exploded perspective view of the electrode structural body.

FIG. 4 is an exploded perspective view of the electrode structural body, and is shown by being viewed from a direction opposite to FIG. 3.

FIG. 5 is a front view of the electrode structural body.

FIG. 6 is a right side view of the electrode structural body.

FIG. 7 is a plan view of the electrode structural body.

FIG. 8 is a bottom view of the electrode structural body.

FIG. 9 is a cross-sectional view taken along a line A to A in FIG. 5.

FIG. 10 is a cross-sectional view taken along a line D to D in FIG. 7.

FIG. 11 is a cross-sectional view taken along a line B to B in FIG. 5.

FIG. 12 is a cross-sectional view taken along a line C to C in FIG. 5.

### BEST MODES OF CARRYING OUT THE INVENTION

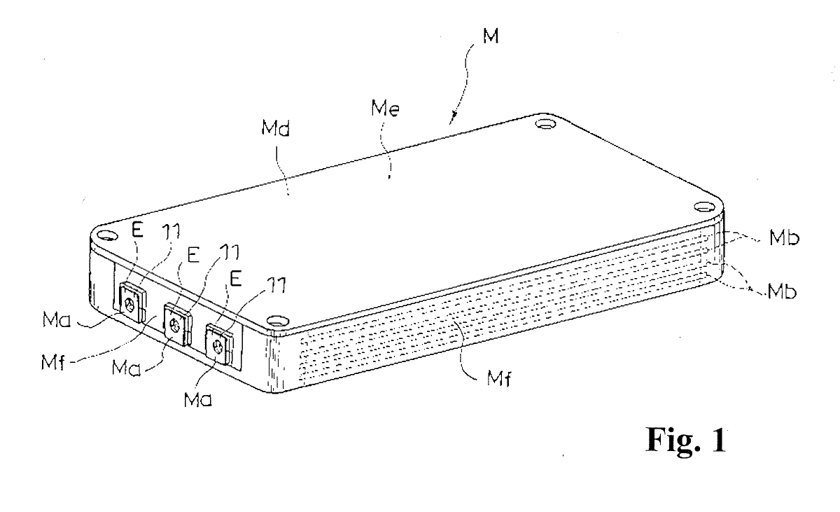

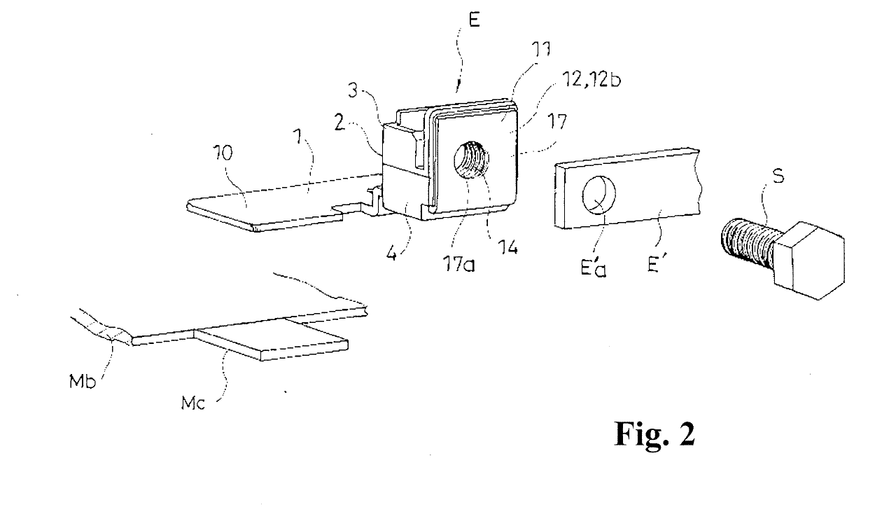

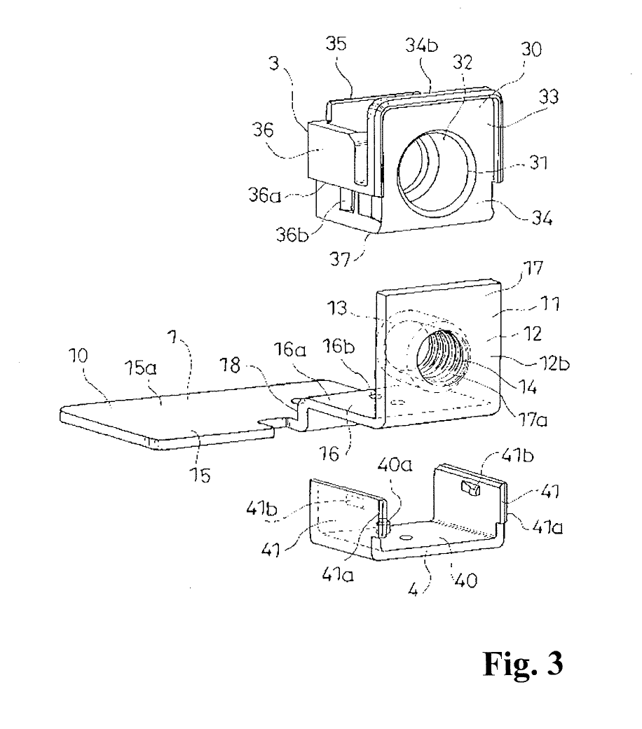

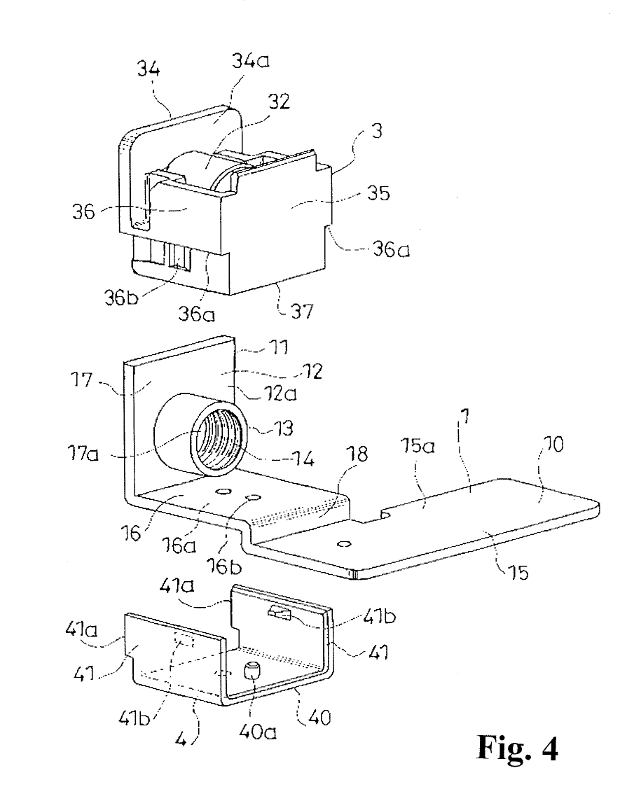

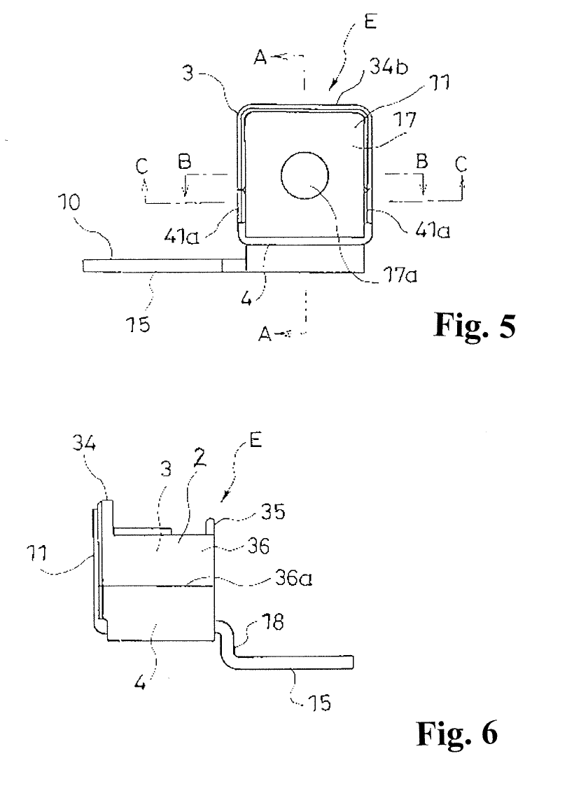

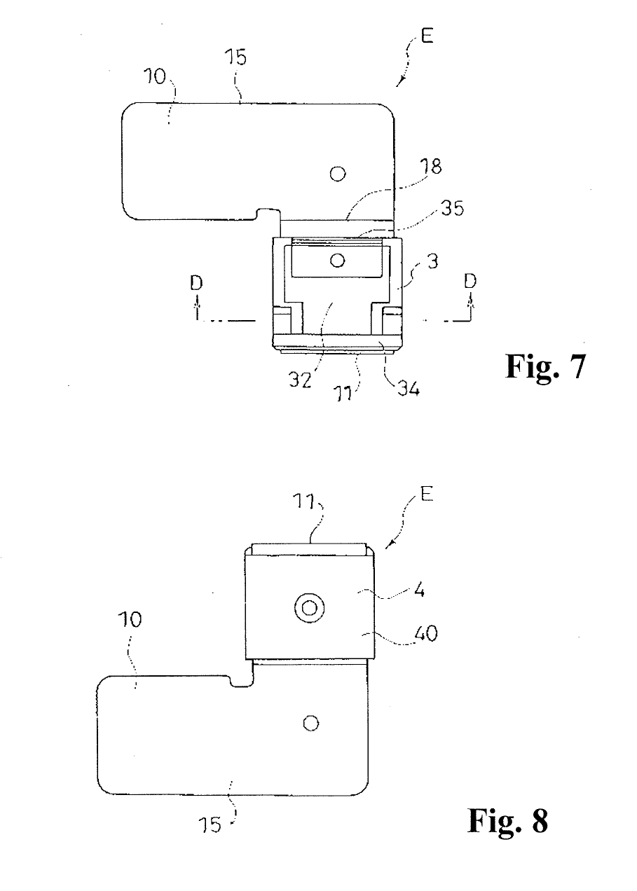

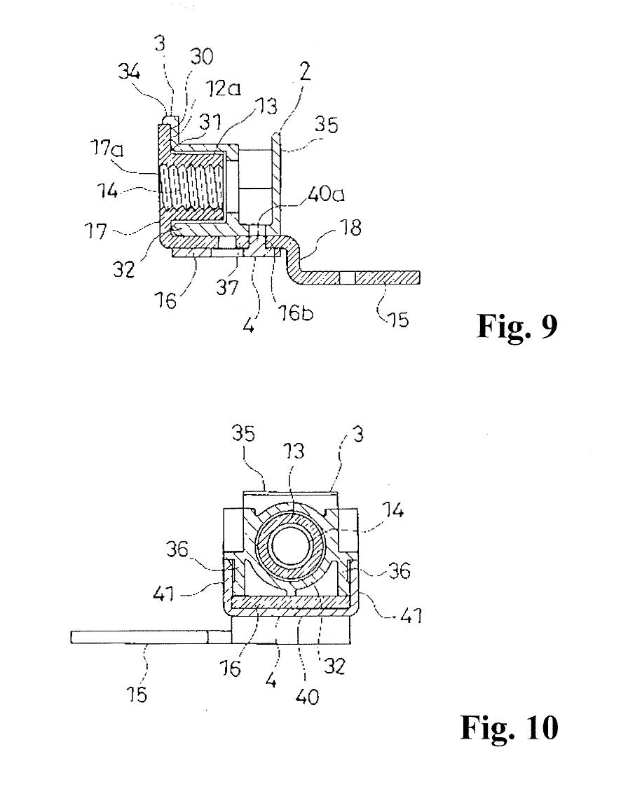

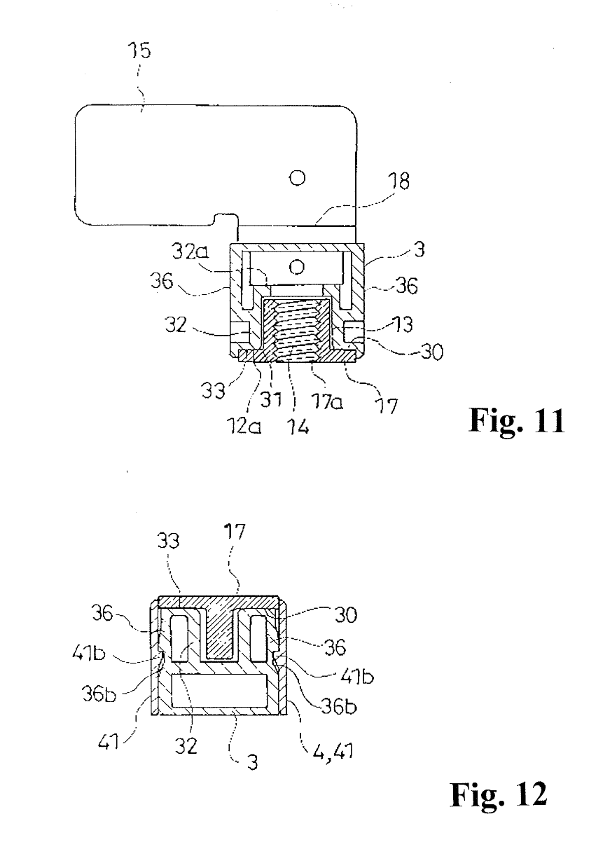

Hereinafter, with reference to FIGS. 1 to 12, an embodiment for carrying out the present invention will be explained. Electrode structural bodies E for a battery module according to the present embodiment, form electrodes Ma of a battery module M by becoming one portion of the battery module M (also called a storage module, a module, and the like) forming a storage system (also called a storage unit and the like) for a hybrid car, an electric car, and the like. Namely, such electrode structural bodies E form electrodes Ma of the battery module M electrically connected to a terminal E′ outside the battery module M. The battery module M comprises storage body cells Mb, and a case Md housing the storage body cells Mb. The storage body cell Mb is structured so as to present a flat plate shape. In an illustrated example, the battery module M is structured by housing a plurality of sheets of the storage body cells Mb in the case Md forming a flat box shape in a state wherein a plurality of sheets of the storage body cells Mb is disposed in a stacking manner. Each storage body cell Mb is connected in series or in parallel by alternately connecting electrodes Mc thereof (usually, called a usual tab and the like).

The electrode structural bodies E are structured by a conducting member 1 made by a metal plate, and an insulation cover 2 made from synthetic resin. Typically, such conducting member 1 is structured by copper or copper alloy.

The conducting member 1 comprises an internal connecting portion 10 electrically connected to the storage body cells Mb, and an external connecting portion 11 electrically connected to the terminal E′ outside the battery module M. In the illustrated example, the aforementioned case Md includes both wide faces Me and Me of an approximately rectangular shape, and side faces Mf on four-thickness sides ranged between both faces Me and Me. Among the side faces Mf on the four-thickness sides, through an opening formed in one side face Mf along a width direction of the case Md, the external connecting portion 11 of the conducting member 1 faces an outward of the case Md. The internal connecting portion 10 of the conducting member 1 is connected to the electrodes Mc of the storage body cells Mb.

The external connecting portion 11 is structured as an upright portion 12 formed by folding an end portion of the metal plate. Then, an outer face 12b of the upright portion 12 is exposed outside the battery module M. With that, in the upright portion 12, there is formed a cylindrical portion 13 comprising a female screw 14 on an inside protruding from an inner face 12a thereof.

In the illustrated example, the conducting member 1 comprises a slender first plate portion 15; a second plate portion 16 extending in a direction orthogonal to the first plate portion 15 from one end portion of the first plate portion 15; and a third plate portion 17 continued from an end portion of the second plate portion 16, and extending in a direction orthogonal to an upper face 16a of the second plate portion 16. The third plate portion 17 functions as the upright portion 12. The upper face 16a of the second plate portion 16 is positioned above an upper face 15a of the first plate portion 15, and in a joint portion between the first plate portion 15 and the second plate portion 16, there is formed a step portion 18.

The cylindrical portion 13 is formed in such a way as to protrude in a direction orthogonal to an inner face of the upright portion 12 from a face on a side facing the upper face 16a of the second plate portion 16, i.e., the inner face of the upright portion 12, in the third plate portion 17. Between the cylindrical portion 13 and the upper face 16a of the second plate portion 16, there is formed an interval. Such cylindrical portion 13 opens both ends of the cylinder. In the third plate portion 17, there is formed an introduction hole for a bolt S communicated with the inside of the cylindrical portion 13. In the illustrated example, a protruding size of the cylindrical portion 13 from the inner face 12a of the upright portion 12 is approximately half of a distance between the inner face 12a and the step portion 18.

The cylindrical portion 13 in such conducting member 1 is formed by a press work relative to the aforementioned metal plate. Also, the female screw 14 is formed in the cylindrical portion 13 by a cutting work. Typically, first, after the cylindrical portion 13 is formed in a sheet of metal plate by a spinning work, a tapping is carried out inside the cylindrical portion 13. After that, from a sheet of the metal plate, an approximately L-shaped plate, in which the first plate portion 15, the second plate portion 16, and the third plate portion 17 are positioned on the same faces, is carved out. Lastly, the step portion 18 is formed in the approximately L-shaped plate, and also a portion which becomes the third plate portion 17 is folded back, and is raised. Thereby, the conducting member 1 is obtained.

The insulation cover 2 includes a front face 30 abutted against the inner face 12a of the upright portion 12, and also comprises a first part 3 comprising a housing portion of the cylindrical portion 13 communicated with a through hole 31 formed in the front face 30; and a second part 4 engaged and combined with the first part 3 in such a way that the first part 3 and the second part 4 sandwich a portion located immediately below the cylindrical portion 13 in the conducting member 1.

In the illustrated example, the first part 3 comprises a front face plate portion 34 of an approximately square shape. A front face 30 of the first part 3 is formed by a front face 33 of the front face plate portion 34. The circular through hole 31 is formed in the front face plate portion 34. The housing portion 32 opens both ends of the cylinder, and also is structured so as to form a cylindrical shape whose one end of the cylinder is integrally connected to a back face 34a of the front face plate portion 34, and whose inner space of the cylinder is communicated with the through hole 31. On the other end of the cylinder of the housing portion 32, there is formed an inner brim 32a.

In the illustrated example, the first part 3 comprises a back face plate portion 35 disposed by opening an interval between the back face plate portion 35 and the other end of the cylinder of the housing portion 32; both right-and-left side portions 36 and 36 ranged between the back face plate portion 35 and the front face plate portion 34; and a bottom portion 37. The housing portion 32 is located inside a space surrounded by the back face plate portion 35, both right-and-left side portions 36 and 36, and the bottom portion 37.

A distance between the front face plate portion 34 and the back face plate portion 35 is slightly smaller than a distance between the upright portion 12 of the conducting member 1 and the step portion 18. Also, the first part 3 narrows an interval between outer faces of both right-and-left side portions 36 and 36 in the bottom portion 37 side. In both right-and-left side portions 36 and 36, there are respectively formed step portions 36a facing the bottom portion 37 side, and the second part 4 and the first part 3 are combined by housing the later-mentioned side walls of the second part 4 under the step difference. Also, in the illustrated example, an upper edge of the front face plate portion 34 of the first part 3, and right-and-left side edges above the step difference are rimmed by a rib-like rim portion 34b.

In the illustrated example, the second part 4 comprises a plate-like base portion 40, and right-and-left side plate portions 41 and 41. A distance between inner faces of the right-and-left side plate portions 41 and 41 is approximately equal to the interval between the outer faces of the right-and-left side portions 36 and 36 of the first part 3, and a width of the second plate portion 16 of the conducting member 1. Also, a front-back size of such plate-like base portion 40 and the right-and-left side plate portions 41 and 41 is approximately equal to the distance between the front face plate portion 34 and the back face plate portion 35 of the first part 3. Also, a protruding size of the right-and-left side plate portions 41 and 41 from the plate-like base portion 40 is approximately equal to a size in which a thickness of the conducting member 1 is added to a distance between the step portion 36a and the bottom portion 37 of the first part 3. Namely, in the illustrated example, by the right-and-left side plate portions 41 and 41 of such second part 4, the second part 4 comprises a pair of side walls housing the bottom portion 37 side of the first part 3 therebetween.

In front edges of the right-and-left side plate portions 41 and 41 of the second part 4, there are respectively formed rim portions 41a continuing to the rib-like rim portion 34b when the second part 4 is combined with the first part 3. Also, in upper edge portions and inner faces of the right-and-left side plate portions 41 and 41 of the second part 4, there are respectively formed latch-engaging portions 41b relative to latch-engaged portions 36b of the first part 3 in an approximately middle position in a front-back direction. On the other hand, in both right-and-left side portions 36 and 36 of the first part 3, and under the step difference due to the step portions 36a, there are respectively formed such latch-engaged portions 36b. In the illustrated example, such latch-engaging portions 41b are structured as projections, and such latch-engaged portions 36b are structured as concave portions in which the projections are housed. Then, after the bottom portion 37 of the first part 3 is housed between the right-and-left side plate portions 41 and 41 while the distance between the right-and-left side plate portions 41 and 41 of the second part 4 is pushed out by elastically deforming the second part 4, in a position wherein the upper edge portions of the right-and-left side plate portions 41 and 41 are bumped into the step portions 36a, the right-and-left side plate portions 41 and 41 return to bend, so that the projections are entered into the concave portions, and the first part 3 and the second part 4 are engaged and combined.

Specifically, up to a position wherein the front face 30 of the first part 3 is abutted against the inner face 12a from an inner face 12a side of the upright portion 12 of the conducting member 1, the cylindrical portion 13 of the conducting member 1 is inserted into the housing portion 32 of the first part 3 through the through hole 31. After that, while the portion (i.e., the second plate portion 16) located immediately below such cylindrical portion 13 of such conducting member 1 is being located between the first part 3 and the second part 4, the second part 4 is engaged and combined with the first part 3. In the combined state, the outer faces on an upper portion side of the right-and-left side portions 36 and 36 of the first part 3, and outer faces of the right-and-left side plate portions 41 and 41 of the second part 4, are positioned on the same faces. In the upright portion 12 of the conducting member 1, an end face on a thickness side thereof is covered by the rib-like rim portion 34b and the rim portions 41a. Incidentally, in the illustrated example, in the combined state, there is formed a protruding portion 40a, which enters into a small hole 16b formed in the second plate portion 16 of the conducting member 1, in the plate-like base portion 40 of the second part 4.

According to the electrode structural bodies E with respect to the present embodiment, first, electrodes Ma side of the battery module M which is electrically connected relative to the terminal E′ outside the battery module M, i.e., an upright portion 12 side of the conducting member 1, can be easily and appropriately covered by the insulation cover 2 which is made by combining the first part 3 and the second part 4. The first part 3 and the second part 4 can be structured by simple synthetic resin molding, so that the cost of components can be a requisite minimum as well. Also, according to such electrode structural bodies E, secondly, a connection of the terminal E′ outside the battery module M into the upright portion 12 of the conducting member 1 can be carried out by the bolt S which is screwed in the cylindrical portion 13 through a hole E′a provided in the terminal E′. Also, the cylindrical portion 13 is integrally provided in the conducting member 1 by the press work, so that a separate nut and the like are not required so as to implement minimization of the number of components from this perspective as well. Also, in that way, an area of the outer face 12b of the upright portion 12 making a contact with the terminal E′ outside the battery module M can be secured in as large an area as possible. Also, according to such electrode structural bodies E, thirdly, the first part 3 covering the inner face 12a and the cylindrical portion 13 of the upright portion 12 is housed between a pair of the side walls of the second part 4 (between the right-and-left side plate portions 41 and 41) so as to be capable of effectively increasing an insulating distance due to an overlapping margin of the first part 3 and the second part 4.

All contents of the specification, claims, drawings, and abstract of Japanese Patent Application No. 2010-034523 filed on Feb. 19, 2010 are cited in their entireties herein and are incorporated as a disclosure of the specification of the present invention.

1. An electrode structural body for a battery module, forming an electrode of the battery module in which a storage body cell is housed in a case, comprising:
a conducting member made by a metal plate; and
an insulation cover made from synthetic resin,
wherein the conducting member includes an internal connecting portion electrically connected to the storage body cell, and an external connecting portion electrically connected to a terminal outside the battery module,
the external connecting portion is an upright portion formed by folding an end portion of the metal plate, and an outer face of the upright portion is exposed outside the battery module and includes a cylindrical portion with a female screw on an inside protruding from an inner face thereof,
the cylindrical portion is formed by a press work relative to the metal plate, and in the cylindrical portion, the female screw is formed by a cutting work, and
the insulation cover comprises
a first part covering at least the inner face of the upright portion, and the cylindrical portion, and
a second part engaged and combined with the first part in such a way that the first part and the second part sandwich a portion located immediately below the cylindrical portion in the conducting member.

2. An electrode structural body for a battery module according to claim 1, wherein the first part includes a front face abutting against the inner face of the upright portion, and a housing portion of the cylindrical portion communicated with a through hole formed in the front face.

3. An electrode structural body for a battery module according to claim 1, wherein the second part includes a pair of side walls housing at least one portion of the first part therebetween.
